(19) United States
(12) Patent Application Publication
(10) Pub. No.: US 2013/0173717 A1
(43) Pub. Date: Jul. 4, 2013

(54) METHOD OF ENFORCING METERED DATA USAGE

(71) Applicants: Ramaswamy Subramanian, Ottawa (CA); Tiru Kumar Sheth, Ottawa (CA)

(72) Inventors: Ramaswamy Subramanian, Ottawa (CA); Tiru Kumar Sheth, Ottawa (CA)

(73) Assignee: Alcatel-Lucent Canada Inc., Ottawa (CA)

(21) Appl. No.: 13/342,408

(22) Filed: Jan. 3, 2012

(51) Int. Cl. G06F 15/16; G06F 15/173

(52) U.S. Cl. 709/206; 709/224

(57) ABSTRACT

A method and system for enforcing metered data usage is disclosed for automatically providing top-ups to a cumulative user data quota. The method for enforcing metered data includes determining cumulative data usage associated to a customer, comparing the cumulated data usage to a quota threshold, and in the event that the cumulated data usage exceeds the threshold, to automatically apply a quota top-up if one is provided for in an associated customer plan. This allows the customer data transfers to continue without requiring manual intervention on the part of the service provider in the event that quota is exceeded. The method and system for enforcing metered data usage also provides for expressing cumulative data usage in terms of a percentage of base quota, thereby facilitating determination if an increase in base quota should be arranged.

### FIELD OF THE INVENTION

The invention relates to service provider monitoring of customer data usage and mores specifically to automatic top-up of customer data quotas.

### BACKGROUND OF THE INVENTION

Network service providers, such as Internet Service Providers (ISPs) provide data service plans that specify upload and download rates as well as quotas as to how much data may be transferred during a contractual period.

When a customer reaches their contracted quota ongoing data services are typically blocked pending the contractual arrangement of a new quota.

As a particular customer quota limit may be reached at any time in a given period dependent upon previous cumulative usage, and given the delays and costs associated with having to take manual action to arrange a new contractual quota, it would be desirable to have a system and method that improved upon existing methods of enforcing metered data limits that minimizes the drawbacks and limitations of the present art.

### SUMMARY OF THE INVENTION

It is an object of the invention to provide a method and system for customer metering quotas which provides for automatic metering quota top-ups.

According to an aspect of the invention there is provided a method of enforcing in a monitoring network element metering quotas associated to a customer plan having a base quota amount, the monitoring network element in communication with an edge network element connected to a unit of customer equipment, the customer equipment associated to the customer plan and the method having the steps of: establishing a percent threshold; receiving at the monitoring network element a usage quantity associated with the customer equipment from the edge network element; calculating at the monitoring network element using the usage quantity a cumulative usage percent associated to the customer plan as a percentage of the base quota amount; checking at the monitoring network element if the cumulative usage percent is less than the percent threshold, and in the event that this check result is affirmative, then returning to the receiving step; and in the event that this check result is negative then checking at the monitoring network element if the customer plan has an unused top-up amount, and in the event that this check is negative, then instructing the edge network element to respond to communication requests from the customer equipment by redirecting the customer equipment communication requests; and in the event that this check is affirmative, then updating the percent threshold as the total sum of the base quota amount plus the unused top-up amount plus all previously used top-up amounts, as a percentage of the base quota amount, and then returning to the receiving step.

In some embodiments of the invention the method has the step of providing an accounting message after the receiving. In some of these embodiments the accounting message contains the usage quantity while in other of these embodiments the accounting message contains the cumulative usage percent.

In other embodiments of the invention the method has the step of providing a notification to a customer associated with the customer plan after the updating step. In some of these embodiments the notification is an email message.

In yet other embodiments of the invention the method has the step of providing a notification to a customer associated with the customer plan after the instructing step. In some of these embodiments the notification is an email message.

According to another aspect of the invention there is provided a system for enforcing metering quotas associated to a customer plan having a base quota amount, the system having a monitoring network element; the monitoring network element configured for communication with an edge network element connected to a unit of customer equipment associated to the customer plan; the monitoring network element configured to establish a percent threshold; the monitoring network element configured to receive a usage quantity associated with the customer equipment from the edge network element; the monitoring network element configured to calculate using the usage quantity a cumulative usage percent associated to the customer plan as a percentage of the base quota amount; the monitoring network element configured to check if the cumulative usage percent is less than the percent threshold, and further configured to in the event that this check result is negative then check if the customer plan has an associated unused top-up amount, and further configured to instruct the edge network element to respond to communication requests from the customer equipment by redirecting the customer equipment communication requests in the event that this check is negative; and further configured to update the percent threshold as the total sum of the base quota amount plus the unused top-up amount plus all previously used top-up amounts, as a percentage of the base quota amount in the event that this check is affirmative.

In some embodiments of the system the monitoring network element is further configured to respond to receiving the usage amount by providing an accounting message. In some of these embodiments the accounting message contains the usage quantity, while in other of these embodiments wherein the accounting message contains the cumulative usage percent.

In other embodiments of the system the monitoring network element is further configured to provide a notification to a customer associated with the customer plan subsequent to the updating the percent threshold. In some of these embodiments the notification is an email message.

In yet other embodiments of the system the monitoring network element is further configured to provide a notification to a customer associated with the customer plan subsequent to the instructing the edge network element. In some of these embodiments the notification is an email message.

According to yet another aspect of the invention there is provided an article of manufacture having a tangible and non-transitory machine-readable storage medium encoded with instructions thereon for execution by a monitoring network element in a communication network, the communication network comprising an edge network element connected to a unit of customer equipment associated to a customer plan having a base quota amount, wherein the tangible and non-transitory machine-readable storage medium having instructions for establishing a percent threshold; instructions for receiving at the monitoring network element a usage quantity associated with the customer equipment from the edge network element; instructions for calculating at the monitoring network element using the usage quantity a cumulative usage percent associated to the customer plan as a percentage of the base quota amount; instructions for checking at the monitoring network element if the cumulative usage percent is less than the percent threshold, and in the event that this check result is affirmative, then returning to the receiving step; and instructions for in the event that this check result is negative then checking at the monitoring network element if the customer plan has an unused top-up amount, and in the event that this check is negative, then instructing the edge network element to respond to communication requests from the customer equipment by redirecting the customer equipment communication requests; and instructions for in the event that this check is affirmative, then updating the percent threshold as the total sum of the base quota amount plus the unused top-up amount plus all previously used top-up amounts, as a percentage of the base quota amount, and then returning to the receiving step.

Note: in the following the description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

### BRIEF DESCRIPTION OF THE DRAWINGS

The present invention will be further understood from the following detailed description of embodiments of the invention, with reference to the drawings in which like reference numbers are used to represent like elements, and:

FIG. 1 illustrates a network having customer equipment connected thereto according to the prior art;

FIG. 2 illustrates table showing alternative customer plans according to an embodiment of the invention;

FIG. 3 illustrates a transaction flow diagram according to an embodiment of the invention; and

FIG. 4 illustrates a flowchart of a method of enforcing metered data usage according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

The techniques shown in the figures can be implemented using code and data stored and executed on one or more electronic devices (e.g., a network element). Such electronic devices store and communicate (internally and with other electronic devices over a network) code and data using machine-readable media, such as machine storage media (e.g., magnetic disks; optical disks; random access memory; read only memory; flash memory devices) and machine communication media (e.g., electrical, optical, acoustical or other form of propagated signals—such as carrier waves, infrared signals, digital signals, etc.). In addition, such electronic devices typically include a set of one or more processors coupled to one or more other components, such as a storage device, one or more user input/output devices (e.g., a keyboard and/or a display), and a network connection. The coupling of the set of processors and other components is typically through one or more busses and bridges (also termed as bus controllers). The storage device and signals carrying the network traffic respectively represent one or more machine storage media and machine communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

As used herein, a network element (e.g., a router, switch, bridge, etc.) is a piece of networking equipment, including hardware and software that communicatively interconnects other equipment on the network (e.g., other network elements, computer end stations, etc.). Customer computer end stations (e.g., workstations, laptops, palm tops, mobile phones, etc.) access content/services provided over the Internet and/or content/services provided on associated networks such as the Internet. The content and/or services are typically provided by one or more server computing end stations belonging to a service or content provider, and may include public webpages (free content, store fronts, search services, etc.), private webpages (e.g., username/password accessed webpages providing email services, etc.), corporate networks over VPNs, etc. Typically, customer computing end stations are coupled (e.g., through customer premise equipment coupled to an access network, wirelessly to an access network) to edge network elements, which are coupled through core network elements of the Internet to the server computing end stations.

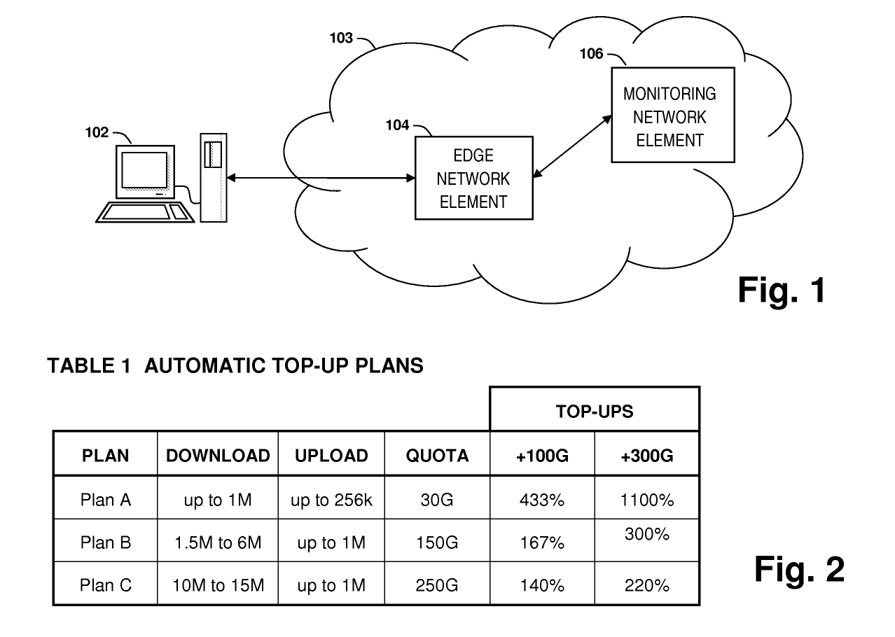

Referring to now to FIG. 1 there may be seen a unit of customer equipment 102 connected to an edge network element 104 located within communication network 103. Edge network element 104 is further connected to monitoring network element 106, also located in communication network 103.

Communication network 103 may be a network (e.g., the Internet or another network of communications devices) for providing data communications between user equipment 102 and other devices connected to communication network 103. Communication network 103 may further provide, for example, phone and/or Internet service to various user devices in communication with communication network 103.

Customer equipment 102 may be a device that communicates with communication network 103 for providing an end-user with a data service. Such data service may include, for example, voice communication, text messaging, multimedia streaming, and Internet access. More specifically, in various exemplary embodiments, customer equipment 102 is a personal or laptop computer, wireless email device, cell phone, television set-top box, or any other device capable of communicating with other devices via edge network element 104.

Edge network element 104 may be a router, switch, bridge, or similar networking equipment, including hardware and software that communicatively interconnects customer equipment 102 to other equipment on the network.

Monitoring network element 106 may be a device that monitors customer usage and manages customer sessions based on customer policies and usage information. One example of monitoring network element 106 is the Alcatel-Lucent 5750 Subscriber Services Controller which administers subscriber entitlements, service definitions and policies (rules) to perform functions including Network Access Control—subscriber and device authentication, IP address management for home devices, subscriber location information for presence-based applications; On-Demand Service Control—automated computation of the required network resources to support the changing subscriber's multimedia service mix & options and dynamic implementation of the resulting policies using RADIUS, DHCP protocols or EMS adaptation; and Application Admission Control—accept or deny IMS and non-IMS on-demand application requests based on revenue priority and bandwidth availability in the wireline network.

In operation, the user equipment 102 is associated with a customer having a customer plan which provides for a specified quota of data transfer. The quota establishes a quantitative ceiling under which cumulative usage must remain for a given contractual period. Edge network element 104 communicates customer data usage to monitoring network element 106 which calculates cumulative customer data usage and compares it to the quota established in the respective customer plan.

According to an embodiment of the invention there is provided an initial quota which can be supplemented by top-up quota increments in the event that cumulative customer data usage exceeds the initial quota. Referring now to FIG. 2 there may be observed Table 1 “Automatic Top-Up Plans” which exhibits a set of alternative exemplary plans that may be chosen by a customer. According to Table 1 there is a choice of plans, each having an associated upload and download rate, a quota, and a pair of quota top-up amounts. For example, Plan A provides for download rates ranging up to 1 M, upload rates ranging up to 256 k, and a cumulative data usage quota of 30 G. The first top-up of 100 G would establish a new quota threshold 433% higher than the initial 30 G threshold, whereas the second top-up of 300 G would establish a new quota threshold 1100% higher than the initial 30 G threshold. Similarly, Plans B and C provide alternative associated upload and download rates and initial quota.

An important aspect of Table 1 is the way in which the top-ups are represented in terms of a percentage of the initial quota. When cumulative customer data usage is calculated as a percentage of the initial quota and communicated to the customer, the customer is better able to gauge the extent to which the initial quota associated with their chosen plan represents their actual data usage. For example, a customer choosing Plan A whose cumulative data usage totaled 60 G would be notified that they were using 200% of their plan quota, and that the next quota threshold would be at 433%. This would enable them to assess the utility of upgrading to a different plan having a higher initial quota threshold.

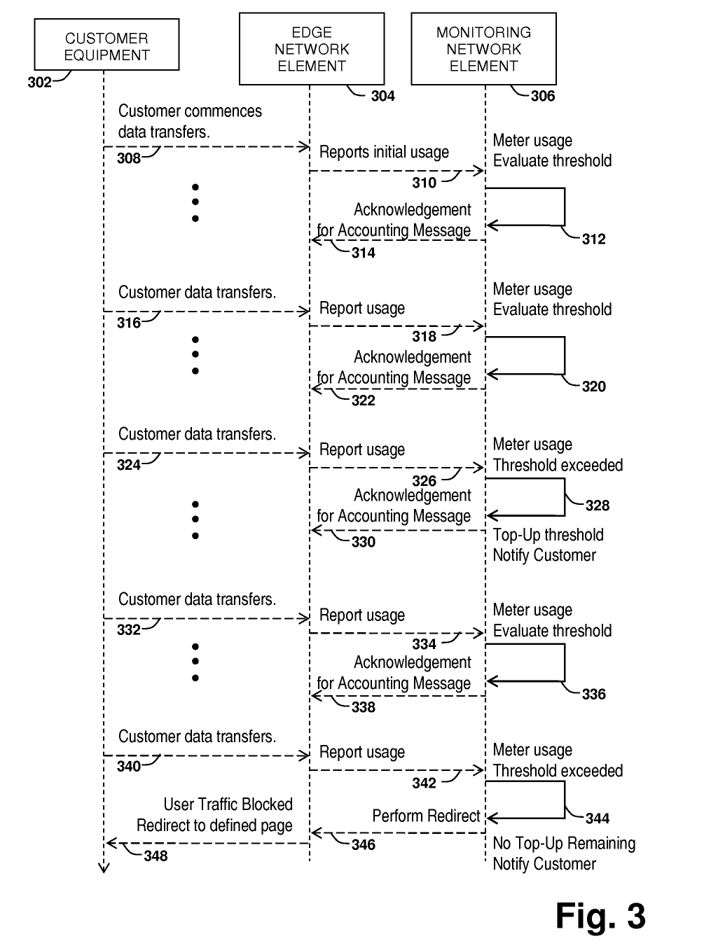

Referring now to FIG. 3, there may be seen a flow diagram representing transactions between customer equipment 302, edge network element 304 and monitoring network element 306 according to an embodiment of the invention. During use, customer equipment 302 commences data transfers with edge network element 304 at 308. Edge network element 204 reports this usage to monitoring network element 306 at 310. Monitoring network equipment meters the usage i.e. calculates a total cumulative usage for the associated customer, and then evaluates it against the initial threshold established in the associated customer plan and confirms that the total cumulative usage is below the initial threshold. Monitoring network element 306 then provides an acknowledgement for the purposes of accounting messaging at 314.

This sequence of flows is repeated at flows 316, 318, 320, and 322 for instances wherein the monitoring network equipment continues to confirm that cumulative customer data usage is below the initial threshold.

At 324 a customer data transfer is reported at 326 and at 328 monitoring network element 306 determines that cumulative customer data usage exceeds the initial threshold. According to the associated customer plan, the initial threshold is topped up and set to a new threshold corresponding to the base quota plus the top-up amount. A notification is sent to the customer that the quota has been exceeded and a top-up performed and at 330 an acknowledgement for accounting message is sent.

At 332 subsequent customer data transfers occur, and are reported at 326. The resultant cumulative customer data usage is calculated and compared against the new threshold. Having confirmed that the cumulative data usage is below the new threshold, monitoring network element 306 then provides an acknowledgement for the purposes of accounting messaging at 338.

Subsequent repetitions of this latter sequence may occur.

At 340 a customer data transfer occurs, and the usage is reported at 342, and the monitoring network element calculates the cumulative customer data usage and determines that the new threshold is exceeded, Should there be additional top-ups remaining in the associated customer plan, monitoring network element 306 will perform the appropriate top-up and calculate a new associated threshold and proceed as per flow 338. However, in the event that there are no top-ups remaining in the associated customer plan, monitoring network element 306 will notify the customer that they have reached their cumulative data quota according to their plan at 344. Monitoring network element 306 will then instruct edge network equipment 304 to perform a redirect of customer user data communications at 346. Edge network equipment 304 then acts to block outgoing data communications from customer equipment 302 to other elements in the network and redirects customer data requests to a predefined page at 348. The predefined page could, for example, contain instructions as to how the customer could have their data quota further increased.

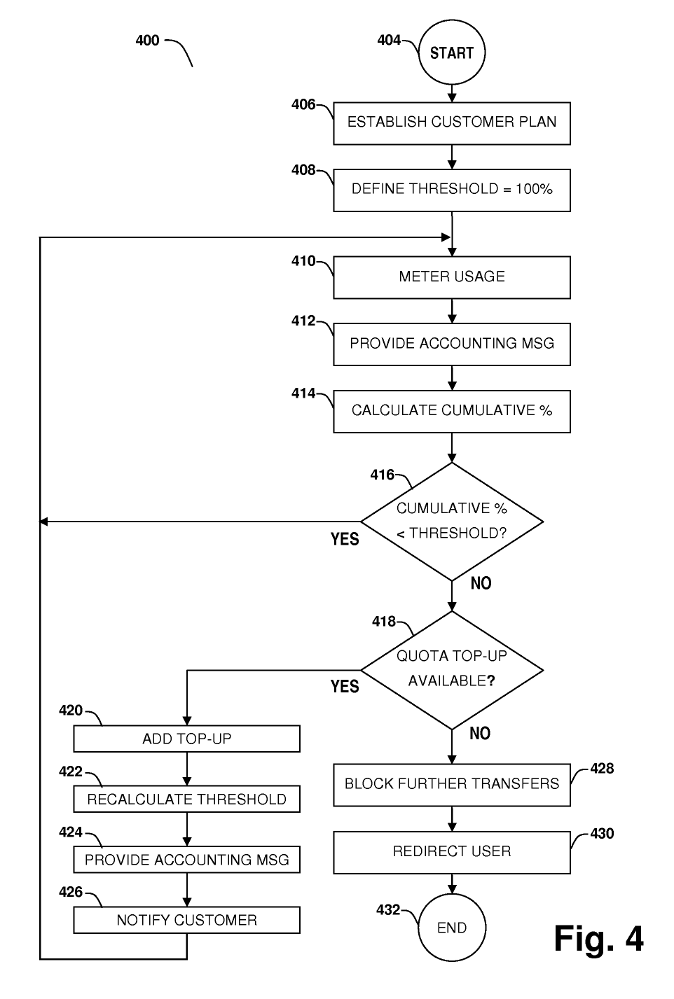

Referring now to FIG. 4 there may be seen a flowchart 400 containing the method steps according to an embodiment of the invention. The method commences at step 404. At step 406 a customer plan is established having an associated cumulative data usage quota, and at step 408 an initial threshold is defined as 100% of the initial cumulative data usage quota according to the customer plan. At step 410 customer data usage is metered i.e. customer data usage quantities are monitored. At step 412 an optional message is provided for accounting purposes. At step 414 the metered customer data usage is summed to produce a cumulative customer data usage quantity and converted to a percentage of the cumulative data usage quota of the associated customer plan. Then, at step 416 the calculated percentage representing the cumulative data usage is compared to the initial threshold.

In the event that the calculated percentage is less than the initial threshold, then control returns to step 410 for further usage metering.

In the event that the calculated percentage is equal to or greater than the initial threshold, control proceeds to step 418 where a check is performed as to whether there remains a top-up quantity according to the associated customer plan.

In the event that the check results of step 418 are affirmative, then at step 420 the appropriate top-up quantity is added and at step 422 the threshold is recalculated.

According to some embodiments of the invention the new threshold is calculated as a percentage of the total sum of the base quota plus applied top-ups, relative to the base quota amount provided for in the associated plan.

This may be expressed in formula form as:

$${T}_{NEW} = \frac{{Quota}_{Base} + \sum Top - {Ups}_{applied}}{{Quota}_{Base}}$$

At step 424 an optional message is provided for accounting purposes and at step 426 an optional notification message is provided to the customer associated with the customer plan. Control then returns to step 410 for further usage metering.

In the event that the check results of step 418 are negative, i.e. there are no further quota top-ups remaining according to the associated customer plan, then further customer data transfers are blocked at step 428 and attempts for customer data transfers are redirected at step 430. In some embodiments the redirection is to data, such as a web page, which provides further instructions as to measures the customer may take to obtain either a further quota increase, or other measures so that customer data transfers may resume.

According to the foregoing, various exemplary embodiments provide for a method and system that of enforcing metered customer data usage limits. In particular by providing for automatic quota top-ups when cumulative customer data transfers exceed contractual limits the drawbacks of service interrupting and manual intervention are obviated.

It should be apparent from the foregoing description that various exemplary embodiments of the invention may be implemented in hardware or software running on associated hardware. Furthermore, various exemplary embodiments may be implemented as instructions stored on a machine-readable storage medium, which are read and executed by at least one processor to perform the operations described in detail herein. A machine-readable storage medium may include any tangible and non-transitory mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of enforcing in a monitoring network element metering quotas associated to a customer plan having a base quota amount, said monitoring network element in communication with an edge network element connected to a unit of customer equipment, said customer equipment associated to said customer plan, the method comprising the steps of:
establishing a percent threshold;
receiving at said monitoring network element a usage quantity associated with said customer equipment from said edge network element;
calculating at said monitoring network element using said usage quantity a cumulative usage percent associated to said customer plan as a percentage of said base quota amount;
checking at said monitoring network element if said cumulative usage percent is less than said percent threshold, and in the event that this check result is affirmative, then returning to said receiving step; and
in the event that this check result is negative then checking at said monitoring network element if said customer plan has an unused top-up amount, and in the event that this check is negative, then instructing said edge network element to respond to communication requests from said customer equipment by redirecting said customer equipment communication requests; and
in the event that this check is affirmative, then:
updating said percent threshold as the total sum of the base quota amount plus said unused top-up amount plus all previously used top-up amounts, as a percentage of said base quota amount, and then returning to said receiving step.

2. A method as claimed in claim 1 further comprising after said receiving step the step of providing an accounting message.

3. A method as claimed in claim 2 wherein said accounting message contains said usage quantity.

4. A method as claimed in claim 2 wherein said accounting message contains said cumulative usage percent.

5. A method as claimed in claim 1 further comprising after said updating step the step of providing a notification to a customer associated with said customer plan.

6. A method as claimed in claim 5 wherein said notification comprises an email message.

7. A method as claimed in claim 1 further comprising after said instructing step the step of providing a notification to a customer associated with said customer plan.

8. A method as claimed in claim 7 wherein said notification comprises an email message.

9. A system for enforcing metering quotas associated to a customer plan having a base quota amount, said system comprising
a monitoring network element;
said monitoring network element configured for communication with an edge network element connected to a unit of customer equipment associated to said customer plan;
said monitoring network element configured to establish a percent threshold;
said monitoring network element configured to receive a usage quantity associated with said customer equipment from said edge network element;
said monitoring network element configured to calculate using said usage quantity a cumulative usage percent associated to said customer plan as a percentage of said base quota amount;
said monitoring network element configured to check if said cumulative usage percent is less than said percent threshold, and further configured to in the event that this check result is negative then check if said customer plan has an associated unused top-up amount, and further configured to instruct said edge network element to respond to communication requests from said customer equipment by redirecting said customer equipment communication requests in the event that this check is negative; and
further configured to update said percent threshold as the total sum of the base quota amount plus said unused top-up amount plus all previously used top-up amounts, as a percentage of said base quota amount in the event that this check is affirmative.

10. A system as claimed in claim 9 wherein said monitoring network element is further configured to respond to receiving said usage amount by providing an accounting message.

11. A system as claimed in claim 10 wherein said accounting message contains said usage quantity.

12. A system as claimed in claim 10 wherein said accounting message contains said cumulative usage percent.

13. A system as claimed in claim 9 wherein said monitoring network element is further configured so that subsequent to said updating said percent threshold, to provide a notification to a customer associated with said customer plan.

14. A system as claimed in claim 13 wherein said notification comprises an email message.

15. A system as claimed in claim 9 wherein said monitoring network element is further configured so that subsequent to said instructing said edge network element, to provide a notification to a customer associated with said customer plan.

16. A system as claimed in claim 15 wherein said notification comprises an email message.

17. A tangible and non-transitory machine-readable storage medium encoded with instructions thereon for execution by a monitoring network element in a communication network, said communication network comprising an edge network element connected to a unit of customer equipment associated to a customer plan having a base quota amount, wherein said tangible and non-transitory machine-readable storage medium comprises:
instructions for establishing a percent threshold;
instructions for receiving at said monitoring network element a usage quantity associated with said customer equipment from said edge network element;
instructions for calculating at said monitoring network element using said usage quantity a cumulative usage percent associated to said customer plan as a percentage of said base quota amount;
instructions for checking at said monitoring network element if said cumulative usage percent is less than said percent threshold, and in the event that this check result is affirmative, then returning to said receiving step; and
instructions for in the event that this check result is negative then checking at said monitoring network element if said customer plan has an unused top-up amount, and in the event that this check is negative, then instructing said edge network element to respond to communication requests from said customer equipment by redirecting said customer equipment communication requests; and
instructions for in the event that this check is affirmative, then updating said percent threshold as the total sum of the base quota amount plus said unused top-up amount plus all previously used top-up amounts, as a percentage of said base quota amount, and then returning to said receiving step.
